(19) United States
(12) Patent Application Publication
(10) Pub. No.: US 2018/0040071 A1
(43) Pub. Date: Feb. 8, 2018

(54) SYSTEMS AND METHODS FOR ANALYZING RETIREMENT DATA

(71) Applicant: Votaire, LLC, Indianapolis, IN (US)

(72) Inventors: Tom Totten, Indianapolis, IN (US); Ross Hendrickson, Carmel, IN (US); Sam Weiss, Indianapolis, IN (US); Conor McGuinness, Indianapolis, IN (US)

(21) Appl. No.: 15/671,911

(22) Filed: Aug. 8, 2017

Related U.S. Application Data
(60) Provisional application No. 62/371,947, filed on Aug. 8, 2016.

(51) Int. Cl. G06Q 40/06

(52) U.S. Cl. CPC G06Q 40/06; G06Q 40/08

(57) ABSTRACT

A computer-implemented method for generating a retirement strategy for an individual is provided. The method includes receiving, at a retirement planning computing device, input information associated with the individual, calculating, using the retirement planning computing device, a projected retirement wealth, a customized projected lifespan, and a customized market return for the individual based on the input information, calculating, using the retirement planning computing device, a sustainable annual retirement income for the individual based on the projected retirement wealth, the customized projected lifespan, and the customized market return, calculating, using the retirement planning computing device, a score that is indicative of the individual's projected wellbeing during retirement, automatically generating, using the retirement planning computing device, advice for the individual based on the sustainable annual retirement income and the score, and causing the sustainable annual retirement income, the score, and the advice to be displayed on a user computing device.

### CROSS REFERENCE TO RELATED APPLICATIONS

This application claims the priority of Provisional Patent Application Ser. No. 62/371,947, filed Aug. 8, 2016, which is hereby incorporated by reference in its entirety.

### BACKGROUND

The disclosed subject matter relates to data processing and, more particularly, to a data processing platform that provides an operator interface for receiving input information from an individual and automatically generating a retirement strategy based on the input information.

Increased longevity, or expected lifespan, creates a number of issues for retirement planning. For example, individuals approaching retirement or already in retirement seek to balance spending money to finance their lifestyle while saving enough money to ensure they can continue to finance their lifestyle for the rest of their life. Although there are known systems and methods for determining how much to save for retirement, there are relatively few systems and methods directed to managing spending during retirement to avoid ruin.

As used herein, ruin refers to a scenario where an individual outlives their retirement resources. Accordingly, the risk of ruin refers to the probability that an individual will outlive their retirement resources. One mechanism that an individual may use to facilitate preventing ruin is a qualified longevity annuity contract (QLAC). A QLAC is a deferred income annuity into which an individual pays one or more premiums (collectively, an annuity price), and, in return, the QLAC periodically (e.g., monthly) pays an income (referred to as annuity payments) to the individual until the individual's death. The individual begins paying premiums once the QLAC is executed. Notably, the annuity payments do not begin immediately once the QLAC is executed, but begin when the individual reaches a predetermined age. For example, an individual may enter a QLAC and begin paying premiums at age 60, but the annuity payments may not begin until the individual reaches age 85.

Determining the parameters of an effective retirement strategy for an individual may be relatively difficult. These parameters should ideally vary based on at least the age, goals, health, longevity expectations, and financial status of the individual. However, at least some known retirement planning strategies are based on conceptual economic theories, and do not consider an individual's actual lifestyle, age, or financial status.

### BRIEF DESCRIPTION OF THE DISCLOSURE

In one aspect, a computer-implemented method for generating a retirement strategy for an individual is provided. The method includes receiving, at a retirement planning computing device, input information associated with the individual, calculating, using the retirement planning computing device, a projected retirement wealth, a customized projected lifespan for the individual, and a customized market return for the individual based on the input information, calculating, using the retirement planning computing device, a sustainable annual retirement income for the individual based on the projected retirement wealth, the customized projected lifespan, and the customized market return, calculating, using the retirement planning computing device, a score that is indicative of the individual's projected wellbeing during retirement, automatically generating, using the retirement planning computing device, advice for the individual based on the sustainable annual retirement income and the score, and causing, using the retirement planning computing device, the sustainable annual retirement income, the score, and the advice to be displayed on a user computing device communicatively coupled to the retirement planning computing device.

In another aspect, a retirement planning computing device for generating a retirement strategy for an individual is provided. The retirement strategy computing device includes a memory device, and a processor communicatively coupled to the memory device, the processor configured to receive input information associated with the individual, calculate a projected retirement wealth, a customized projected lifespan for the individual, and a customized market return for the individual based on the input information, calculate a sustainable annual retirement income for the individual based on the projected retirement wealth, the customized projected lifespan, and the customized market return, calculate a score that is indicative of the individual's projected wellbeing during retirement, automatically generate advice for the individual based on the sustainable annual retirement income and the score, and cause the sustainable annual retirement income, the score, and the advice to be displayed on a user computing device communicatively coupled to the retirement planning computing device.

In yet another aspect, a computer-implemented method for recommending a qualified longevity annuity contract (QLAC) for an individual is provided. The method includes receiving, at a retirement planning computing device, input information associated with the individual, calculating, using the retirement planning computing device, an expected longevity for the individual based on the input information, calculating, using the retirement planning computing device, a probability of ruin for the individual based on the expected longevity and the input information, generating, using the retirement planning computing device, a QLAC recommendation for the individual based on the probability of ruin and the expected longevity, the QLAC recommendation including i) an annuity price, ii) an annuity payment start date, and iii) an annuity payment amount, and causing, using the retirement planning computing device, the QLAC recommendation to be presented to the individual.

### BRIEF DESCRIPTION OF THE DRAWINGS

FIGS. 1-18 show example embodiments of the methods and systems described herein.

FIG. 1 is a simplified block diagram of an example retirement strategy system that includes a retirement strategy computing device and other computing devices in accordance with one example embodiment of the present disclosure.

FIG. 2 is an expanded block diagram of an example embodiment of a server architecture of the retirement strategy system including the retirement strategy computing device and a plurality of other computing devices in accordance with one example embodiment of the present disclosure.

FIG. 3 illustrates an example configuration of a client system shown in FIGS. 1 and 2.

FIG. 4 illustrates an example configuration of a server system shown in FIGS. 1 and 2.

FIG. 5 is a flowchart of an example method of generating a retirement strategy for an individual using the retirement strategy system shown in FIGS. 1 and 2.

FIGS. 6-13 are screenshots of an example dashboard that may be displayed as part of the method shown in FIG. 5.

FIG. 14 is a flowchart of an alternative example method of generating a retirement strategy for an individual using the retirement strategy system shown in FIGS. 1 and 2.

FIG. 15 is an illustrating an example longevity calculation.

FIG. 16 is a flowchart of an example method of calculating a probability of ruin.

FIGS. 17 and 18 are flowcharts of an example method of determining a recommended qualified longevity annuity contract (QLAC).

Like numbers in the Figures indicate the same or functionally similar components.

### DETAILED DESCRIPTION OF THE DISCLOSURE

Embodiments of the methods and systems described herein provide a data processing platform that provides an operator interface for collecting information about an individual and causing a retirement planning strategy to be generated and displayed to the individual based on the collected information. In the example embodiment, the information is received at a retirement strategy computing device. Based on the input information, the retirement strategy computing device automatically calculates various parameters for the individual, as described herein.

In the example embodiment, a user (e.g., the individual for whom the retirement strategy is being generated) uses a web-based platform to interact with the retirement strategy computing device. For example, the user may input information into a user interface, or dashboard, displayed on a computing device such that the information input by the user is received and processed by the retirement strategy computing device.

A current retirement wealth (i.e., the amount of retirement wealth the individual current has) is determined based on data collected from the individual regarding their current financial situation. For example, the current retirement wealth may be determined from the current savings, age, gender, marital status, current salary, target retirement age (i.e., the age at which the individual would like to retire), annuities, pension, social security, and/or expenses of the individual. A projected retirement wealth is then calculated based on the current retirement wealth. The projected retirement wealth is the projected initial wealth of the individual at their target retirement age. Accordingly, the projected retirement wealth translates the individual's current wealth and goals into the total wealth the individual is likely to have at their target retirement age. The projected retirement wealth also incorporates income streams the individual will have during retirement, such as social security and annuities.

An estimated longevity and health of the individual are also determined based on data collected from the individual. For example, the individual may provide their date of birth, height, weight, gender, smoking history, alcohol consumption, and/or family medical history. From this, a customized projected lifespan is calculated for the individual. Actuarial mortality tables and historical data may also be used to calculate the projected lifespan.

Investment preferences and goals are also determined for the individual based on data collected from the individual. For example, the individual may provide expected vacation budgets and/or desired charitable donations. Further, the individual may provide a retirement income priority (e.g., whether the individual wants to preserve their principal wealth throughout retirement or expend all of their wealth by the end of retirement).

In some embodiments, individuals can input information to link their existing accounts to the retirement strategy computing device (i.e., such that the retirement strategy computing device can access account information (e.g., account balance, interest rate, etc.) for those accounts to determine an asset allocation for the individual). For individuals who do not link their existing accounts, a customized market return is also calculated for the individual. Specifically, in the example embodiment, the retirement income priority and the age of the individual are used to determine an asset allocation, and that asset allocation is then mapped to a customized market return using stochastic modeling of different asset classes. An individual may also simulate poor, average, and good market returns to see how the market environment affects their retirement plans.

An actuarial calculation is then performed using the projected retirement wealth, the projected lifespan, and the customized market return. Specifically, in the example embodiment, a future wealth value is calculated from these parameters. Notably, in the example embodiment, the future wealth value includes a healthcare/emergency set-aside value that facilitates setting money aside for any health-related issues that may occur during retirement. The healthcare/emergency set-aside value may be determined, for example, based on Medicare and pre-Medicare cost projections made using data specific to the individual's zip code.

An annual non-annuity withdrawal is also calculated. The annual non-annuity withdrawal is the amount the individual will be able to safely withdraw each year during retirement with minimal risk of depleting funds and without being overly conservative. Specifically, based on market environment assumptions (e.g., inflation), the projected lifespan, and the customized market return, a discount factor is calculated. Then, the annual non-annuity withdrawal is calculated from the discount factor and the future wealth value.

Actuarial smoothing is performed to smooth assets inflation every year of retirement to account for real world effects. Further, any additional adjustments, such as modifying an individual's expense ratio if the individual has a spouse that is still working or deceased, may also be made.

Subsequently, a sustainable annual retirement income (i.e., a retirement income that does not result in ruin) is calculated for the individual. Specifically, in the example embodiment, the sustainable annual retirement income is calculated based on the smoothed annual non-annuity withdrawal and any annuity, pension, social security, or other income stream the individual has. A score is also calculated for the individual. The score is generally indicative of the individual's projected wellbeing during retirement based on their projected outlook, and is tied to the individual's potential of meeting ruin. For example, the present value of all future income and expenses for the individual may be calculated based on assumptions regarding inflation, future expenses (e.g., healthcare), and longevity. Based on a ratio between future income and expenses, the individual's readiness for retirement can be assessed and converted to a score. In some embodiments, the score takes into account a probability of ruin for the individual by considering additional expenses and market risk.

In the example embodiment, advice is also automatically generated for the individual. The advice is generated based on the sustainable annual retirement income and the score. In the example embodiment, the advice includes a recommended financial product for the individual. For example, the advice may recommend that the individual purchase a qualified longevity annuity contract (QLAC) (discussed in detail below). The advice may also include advising the purchase of a long-term care policy, proposing Medicare strategies, proposing annuity strategies, projecting tax liability information, and/or proposing charitable giving strategies (e.g., through the use of charitable gift annuities and/or charitable remainder trusts). Further, if the individual's financial situation calls for a product that will improve their sustainable annual retirement income and/or score, the advice may prompt the individual to contact an appropriate professional to discuss the product. For example, the generated advice may include the phone number and/or email address of an appropriate professional. After implementing a suggested product, the impact of the product on the sustainable annual retirement income and/or score may be displayed to the individual.

In the exemplary embodiment, advice information is stored in an advice database in communication with the retirement strategy computing device. Using the sustainable retirement income and score, the retirement strategy computing device queries the advice database to identify advice information that matches the sustainable retirement income and score. The identified advice information is then retrieved by the retirement strategy computing device to display the advice to the user. Notably, retirement strategy computing device is capable of retrieving the advice information and displaying the advice in real-time. Accordingly, advice is generated and displayed to the individual substantially immediately (i.e., in real-time) after the individual inputs pertinent information.

At least one technical problem with known systems is that determining an individual's retirement outlook generally involves complicated and time-consuming calculations that require information from multiple disparate data sources. Further, these calculations may be relatively inaccurate when providing a retirement outlook for the individual. In addition, at least some known systems are incapable of quickly providing an individual with retirement strategies in real-time. The embodiments described herein address at least these technical problems. Specifically, the retirement strategy computing devices described herein receive input information for an individual, and quickly (i.e., in real-time) and efficiently perform a plurality of calculations to generate and display a sustainable annual retirement income and score for the individual. Further, the retirement strategy computing devices described herein automatically generate and display (again, in real-time), based on the input information, retirement advice for the individual. The advice may include, for example, a QLAC recommendation for the individual, including parameters for the recommended QLAC. Further, as users update the input information (e.g., by manipulating a slider), the retirement strategy computing device automatically and dynamically updates a background of a displayed dashboard, providing substantially instantaneous feedback on whether the updated input information improves or worsens a retirement forecast for the individual.

The following detailed description illustrates embodiments of the disclosure by way of example and not by way of limitation. It is contemplated that the embodiments have general application to retirement planning in a variety of applications.

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only and thus are not intended to limit in any way the definition and/or meaning of the term database. Examples of RDBMS's include, but are not limited to including, Oracle® Database, MySQL, Teradata, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a computer-readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The systems and processes are not limited to the specific embodiments described herein. In addition, components of each system and each process can be practiced independently and separate from other components and processes described herein. Each component and process also can be used in combination with other assembly packages and processes.

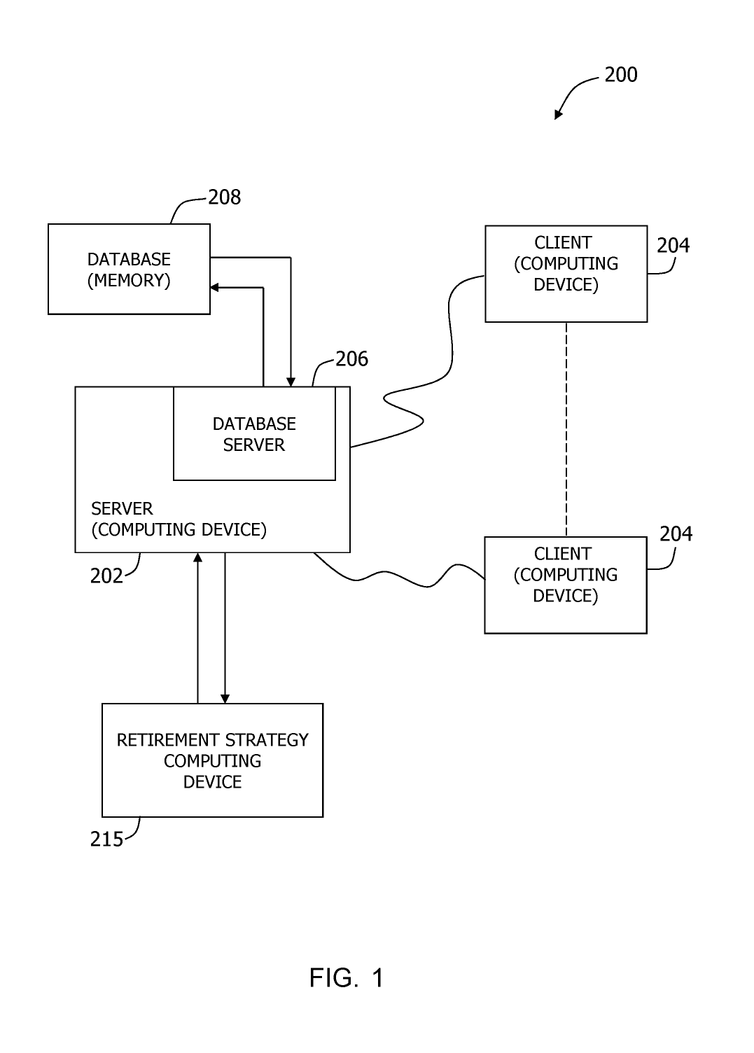

FIG. 1 is a simplified block diagram of one embodiment of a retirement strategy system 200 that includes a retirement strategy computing device 215 in communication with a server system 202 that includes a database server 206. Further, a database 208 is in communication with server system 202 in the example embodiment. Retirement strategy computing device 215 includes a processing device and a memory. System 200 further includes a plurality of client subsystems, also referred to as client systems 204 or client computing devices, connected to server system 202. In one embodiment, client systems 204 are computers including a web browser, such that server system 202 is accessible to client systems 204 using the Internet or another network. Client systems 204 are interconnected to the Internet or another network through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), watch, medical device, kiosk, laptop computer, desktop computer, netbook, tablet, phablet, or other web-connectable equipment.

Database server 206 is connected to database 208 containing information on a variety of matters, as described below in greater detail. In one embodiment, database 208 is stored on server system 202 and may be accessed by potential users at one of client systems 204 by logging onto server system 202 through one of client systems 204. Database 208 is also accessible to retirement strategy computing device 215. In an alternative embodiment, database 208 is stored remotely from server system 202 and may be non-centralized (e.g., in a cloud computing configuration). Server system 202 could be any type of computing device configured to perform the steps described herein. Additionally, retirement strategy computing device 215 is in communication with server system 202. In some implementations, retirement strategy computing device 215 is incorporated into or integrated within server system 202. As described herein, server system 202 collects and stores input information associated with an individual in database 208, and retirement strategy computing device 215 processes the stored input information to generate a QLAC recommendation for the individual.

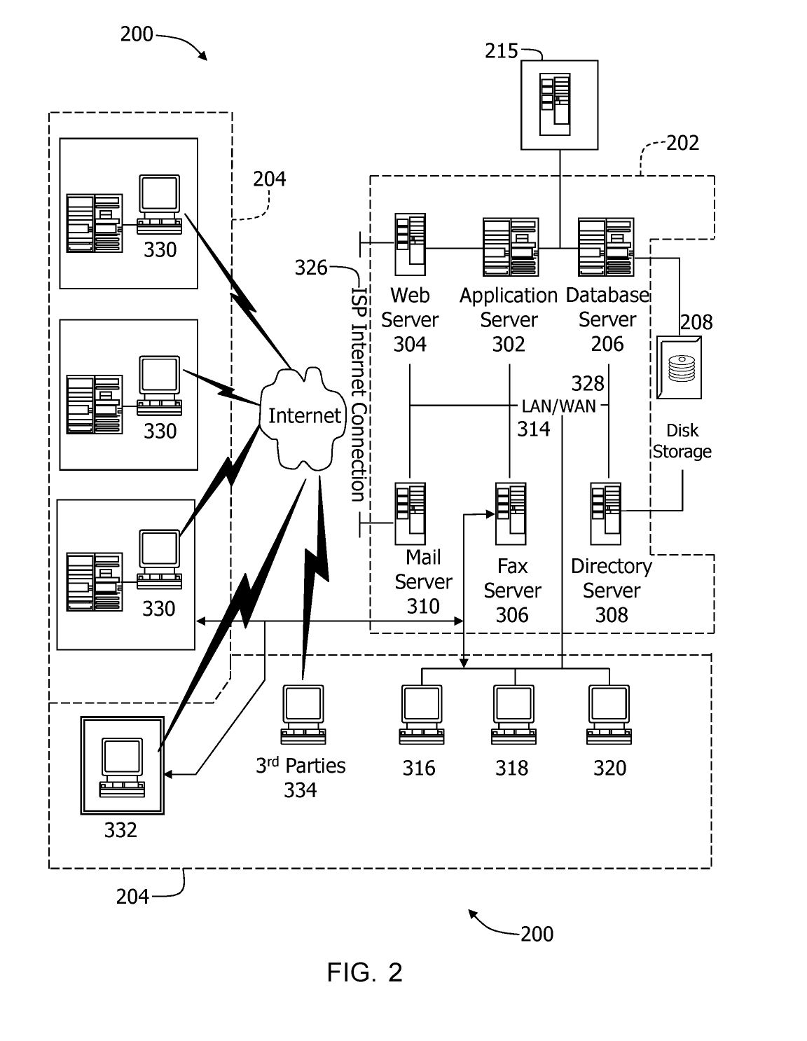

FIG. 2 is an expanded block diagram of an example embodiment of a server architecture of retirement strategy system 200 in accordance with one embodiment of the present disclosure. Retirement strategy system 200 includes client systems 204 and retirement strategy computing device 215. Server system 202 includes database server 206, an application server 302, a web server 304, a fax server 306, a directory server 308, and a mail server 310. Database 208 (e.g., a disk storage unit), is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including third parties 334 using an Internet connection 326. Server system 202 is also communicatively coupled to retirement strategy computing device 215. In some embodiments, retirement strategy computing device 215 is integrated within server system 202. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 200. At least one of the client systems includes a manager workstation 332 located at a remote location. Workstations 330 and 332 include personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

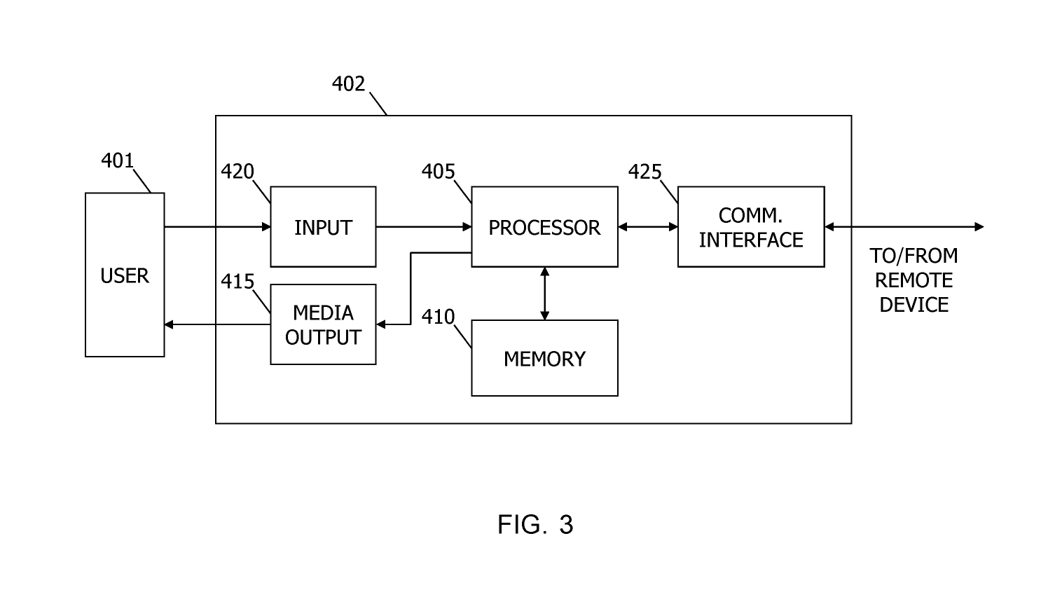

FIG. 3 illustrates an example configuration of an input information computing device 402 operated by a user 401. Input information computing device 402 enables user 401 to provide input information, as described in detail herein. Input information computing device 402 may include, but is not limited to, client systems (“client computing devices”) 204, 316, 318, and 320, workstation 330, and manager workstation 332 (shown in FIG. 2).

Input information computing device 402 includes one or more processors 405 for executing instructions. In some embodiments, executable instructions are stored one or more memory devices 410. Processor 405 may include one or more processing units (e.g., in a multi-core configuration). One or more memory devices 410 are any one or more devices allowing information such as executable instructions and/or other data to be stored and retrieved. One or more memory devices 410 may include one or more computer-readable media.

Input information computing device 402 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, input information computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Input information computing device 402 may also include a communication interface 425, which is communicatively couplable to a remote device such as server system 202. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in one or more memory devices 410 are, for example, computer-readable instructions for providing a user interface to user 401 via media output component 415 and, optionally, receiving and processing input from input device 420. A user interface may include, among other possibilities, a web browser and client application. Web browsers enable users, such as user 401, to display and interact with media and other information typically embedded on a web page or a web site from server system 202. A client application allows user 401 to interact with a server application from server system 202 or a web server.

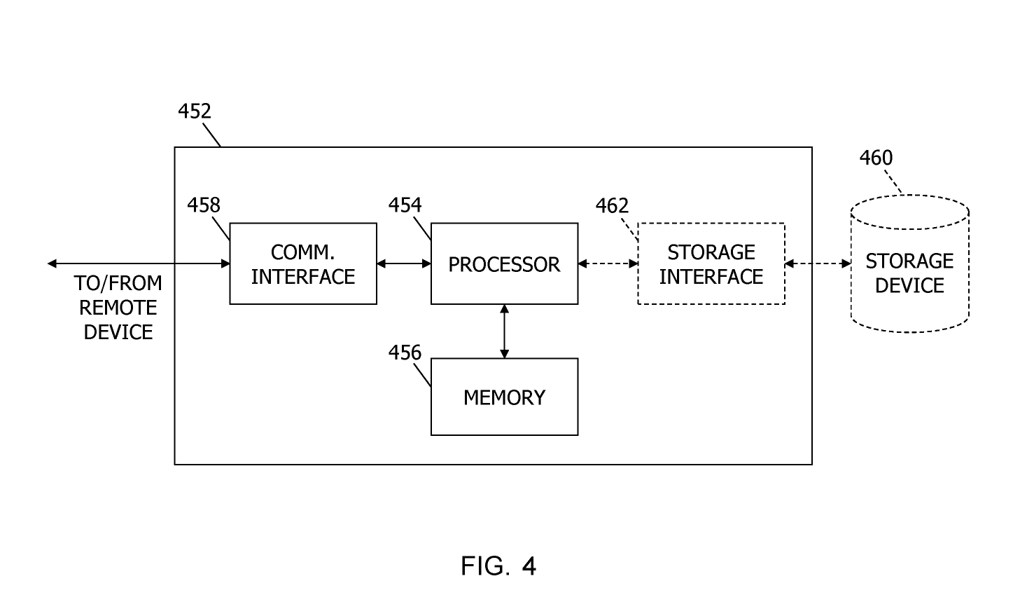

FIG. 4 illustrates an example configuration of a server computing device 452 such as server system 202 (shown in FIGS. 1 and 2). Server computing device 452 may include, but is not limited to, database server 206, application server 302, web server 304, fax server 306, directory server 308, and mail server 310. Server computing device 452 is also representative of retirement strategy computing device 215.

Server computing device 452 includes one or more processors 454 for executing instructions. Instructions may be stored in one or more memory devices 456, for example. One or more processors 454 may include one or more processing units (e.g., in a multi-core configuration).

One or more processors 454 are operatively coupled to a communication interface 458 such that server computing device 452 is capable of communicating with a remote device such as input information computing device 402 or another server computing device 452. For example, communication interface 458 may receive requests from client systems 204 via the Internet or another network, as illustrated in FIGS. 1 and 2.

One or more processors 454 may also be operatively coupled to one or more storage devices 460. One or more storage devices 460 are any computer-operated hardware suitable for storing and/or retrieving data. In some embodiments, one or more storage devices 460 are integrated in server computing device 452. For example, server computing device 452 may include one or more hard disk drives as one or more storage devices 460. In other embodiments, one or more storage devices 460 are external to server computing device 452 and may be accessed by a plurality of server computing devices 452. For example, one or more storage devices 460 may include multiple storage units such as hard disks or solid state disks in a redundant array of inexpensive disks (RAID) configuration. One or more storage devices 460 may include a storage area network (SAN) and/or a network attached storage (NAS) system. In some embodiments, one or more storage devices 460 may include database 208.

In some embodiments, one or more processors 454 are operatively coupled to one or more storage devices 460 via a storage interface 462. Storage interface 462 is any component capable of providing one or more processors 454 with access to one or more storage devices 460. Storage interface 462 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing one or more processors 454 with access to one or more storage devices 460.

One or more memory devices 410 and 456 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

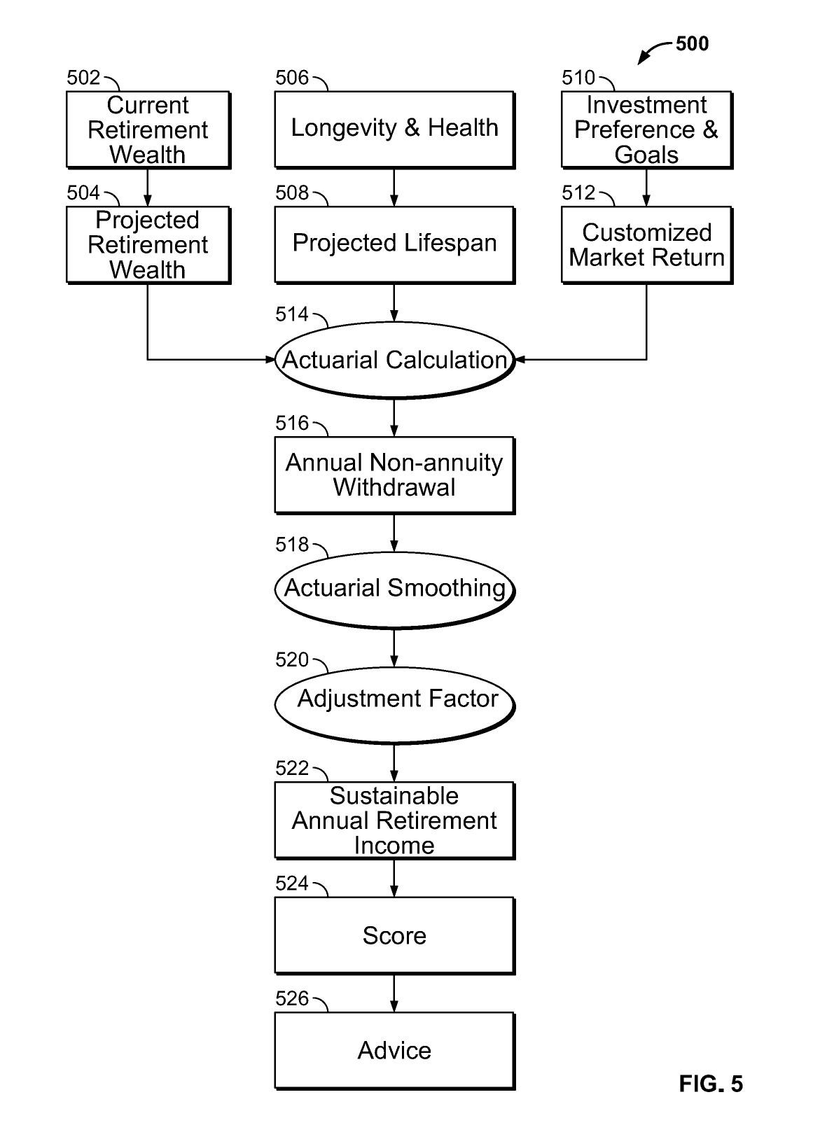

FIG. 5 is a flowchart of an example method 500 of generating a retirement strategy for an individual using retirement strategy system 200 shown in FIG. 1. In the example embodiment, method 500 is performed by retirement strategy computing device 215 (shown in FIG. 1).

In the example embodiment, a user (e.g., the individual for whom the retirement strategy is being generated) uses a web-based platform to interact with retirement strategy computing device 215. For example, the user may input information into a user interface, or dashboard, displayed on input information computing device 402 (shown in FIG. 4), and input information computing device 402 may be communicatively coupled to retirement strategy computing device 215 such that the information input by the user at input information computing device 402 is received and processed by retirement strategy computing device 215.

As shown in FIG. 5, at block 502, a current retirement wealth (i.e., the amount of retirement wealth the individual current has) for the individual is determined. In the example embodiment, the current retirement wealth is determined based on data collected from the individual (e.g., using input information computing device 402) regarding their current financial situation. For example, the current retirement wealth may be determined from the current savings, age, gender, marital status, current salary, target retirement age (i.e., the age at which the individual would like to retire), annuities, pension, social security, and/or expenses of the individual.

At block 504, a projected retirement wealth (i.e., an expected retirement wealth at retirement) is calculated based on the current retirement wealth determined at block 502. The projected retirement wealth is the projected initial wealth of the individual at their target retirement age. Accordingly, the projected retirement wealth translates the individual's current wealth and goals into the total wealth the individual is likely to have at their target retirement age. The projected retirement wealth also incorporates income streams the individual will have during retirement, such as social security and annuities.

At block 506, an estimated longevity and health (e.g., a score indicating how long the individual is likely to live and how health the individual is) of the individual are determined. Similar to the current retirement wealth, these parameters are determined based on data collected from the individual (e.g., using input information computing device 402). For example, the individual may provide their date of birth, height, weight, gender, smoking history, alcohol consumption, and/or family medical history.

At block 508, a customized projected lifespan (i.e., an expected age at which the individual will die) is calculated for the individual based on the estimated longevity and health parameters determined at block 506. In the example embodiment, actuarial mortality tables and historical data are used to calculate the customized projected lifespan. Alternatively, the projected lifespan for the individual may be calculated using any suitable method.

At block 510, investment preferences and goals (e.g., user preferences regarding saving and spending) are determined for the individual. Similar to the current retirement wealth, the investment preferences and goals are determined based on data collected from the individual (e.g., using input information computing device 402). For example, the individual may provide expected vacation budgets and/or desired charitable donations. Further, the individual may provide a retirement income priority (e.g., whether the individual wants to preserve their principal wealth throughout retirement or expend all of their wealth by the end of retirement).

At block 512, a customized market return (i.e., the amount of returns the individual expects to see from the stock market and other investments) is calculated for the individual. Specifically, in the example embodiment, the retirement income priority and the age of the individual are used to determine an asset allocation, and that asset allocation is then mapped to a customized market return using stochastic modeling of different asset classes. An individual may also simulate poor, average, and good market returns to see how the market environment affects their retirement plans.

At block 514, an actuarial calculation is performed using the projected retirement wealth calculated from block 504, the projected lifespan calculated from block 508, and the customized market return from block 512. Specifically, in the example embodiment, a future wealth value is calculated from these parameters. Notably, in the example embodiment, the future wealth value includes a healthcare/emergency set-aside value that facilitates setting money aside for any health-related issues that may occur during retirement.

At block 516, an annual non-annuity withdrawal is calculated. The annual non-annuity withdrawal is the amount the individual will be able to safely withdraw each year during retirement with minimal risk of depleting funds and without being overly conservative. Specifically, based on market environment assumptions (e.g., inflation), the projected lifespan, and the customized market return, a discount factor is calculated. Then, the annual non-annuity withdrawal is calculated from the discount factor and the future wealth value calculated at block 514.

Actuarial smoothing is performed at block 518. Specifically, assets are smoothed by inflation every year of retirement to account for real world effects. At block 520, any additional adjustments are made. The additional adjustments may include, for example, modifying an individual's expense ratio if the individual has a spouse that is still working or deceased.

At block 522, a sustainable annual retirement income (i.e., an annual income that will prevent the user from ruin during retirement) is calculated for the individual. Specifically, in the example embodiment, the sustainable annual retirement income is calculated based on the smoothed annual non-annuity withdrawal and any annuity, pension, social security, or other income stream the individual has.

A score is calculated for the individual at block 524. The score is generally indicative of the individual's projected wellbeing during retirement based on their projected outlook. Further, the score is tied to the individual's potential of meeting ruin. For example, the present value of all future income and expenses for the individual may be calculated based on assumptions regarding inflation, future expenses (e.g., healthcare), and longevity. Based on a ratio between future income and expenses, the individual's readiness for retirement can be assessed and converted to a score. In some embodiments, the score takes into account a probability of ruin for the individual by considering additional expenses and market risk.

At block 526, advice is generated for the individual. The advice is generated based on the sustainable annual retirement income calculated at block 522 and the score calculated at block 524. In the example embodiment, the advice includes a recommended financial product for the individual. For example, the advice may recommend that the individual purchase a qualified longevity annuity contract (QLAC) and indicate one or more suggested parameters (e.g., an annuity price, an annuity payment start date, and an annuity payment amount) for the recommended QLAC (discussed in detail below). Further, if the individual's financial situation calls for a product that will improve their sustainable annual retirement income and/or score, the advice may prompt the individual to contact an appropriate professional to discuss the product. For example, the generated advice may include the phone number and/or email address of an appropriate professional. After implementing a suggested product, the impact of the product on the sustainable annual retirement income and/or score may be displayed to the individual (e.g., on input information computing device 402).

The advice generated at block 526 may also include advising the purchase of a long-term care policy, proposing Medicare strategies, proposing annuity strategies, projecting tax liability information, and/or proposing charitable giving strategies (e.g., through the use of charitable gift annuities and/or charitable remainder trusts).

In some embodiments, based on the expenses, social security income, retirement income, and basic wealth of the individual, the advice includes an annuity strategy that recommends how much the individual should annuitize. For example, if an individual has $50,000 in annual expenses and an annual social security income of $20,000, the system may recommend a $30,000 annuity.

The advice may also include Medicare and/or long-term care recommendations. For example, based on the zip code of the individual and other information known about the individual, the estimated cost of a long-term care policy may be provided. For Medicare, because the expected age of retirement of the individual is known, if the individual plans on retiring before being eligible for Medicare, the advice may include data on how much it will cost to cover healthcare for the individual between the age they retire and the age they become Medicare-eligible. This data may include out of pocket estimates, etc., and may be generated (e.g., using actuarial expertise) based on the zip code and other information known about the individual. Post-retirement benefits may also be taken into account when generating this advice.

In some embodiments, tax liability information is generated as part of the advice. For example, if the individual is planning to move from a first zip code to a second zip code, the advice may indicate the tax liability differences between the first and second zip codes.

Further, the advice may include a charitable giving recommendation. For example, if the individual indicates they want to give a predetermined amount of money to charity, based on the information collected about the individual, a recommendation including an optimal way to achieve that goal may be generated. The recommendation may include, for example, a recommended method and amount of giving.

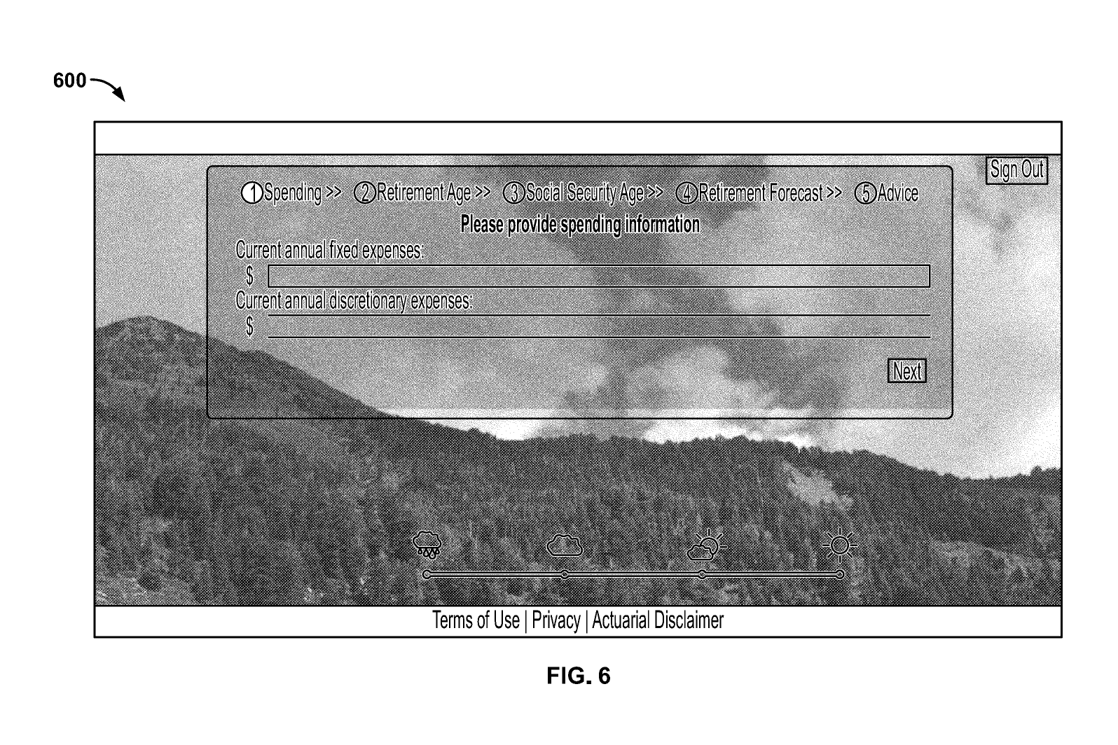

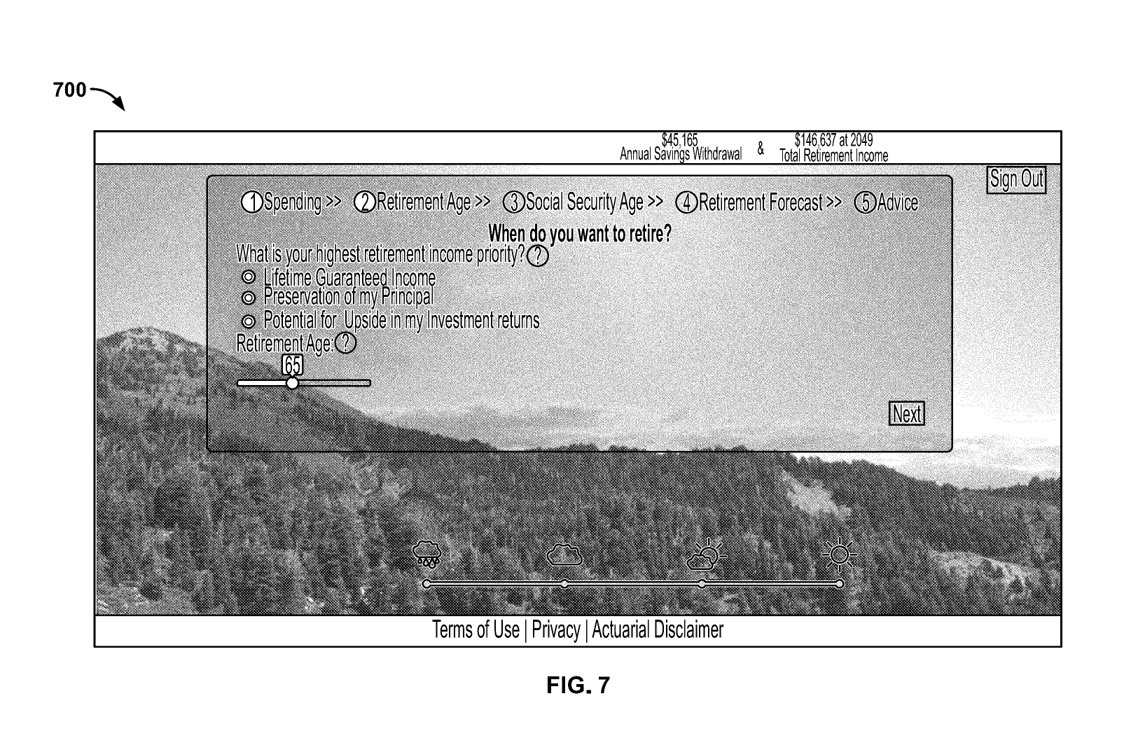

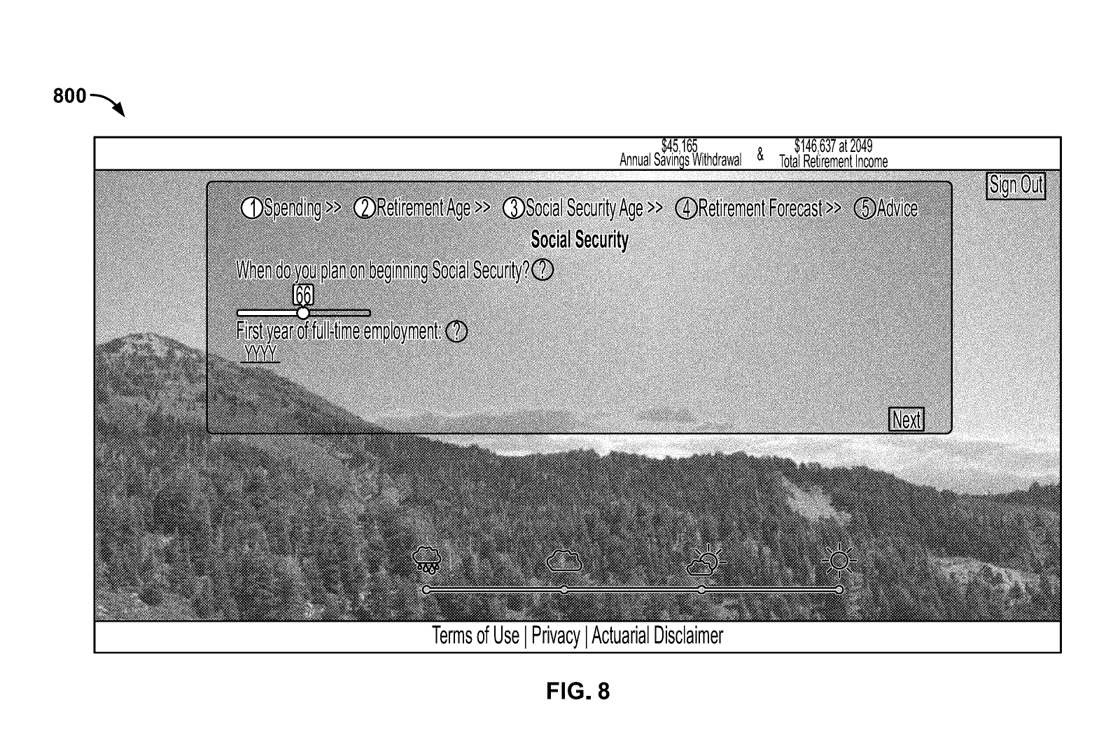

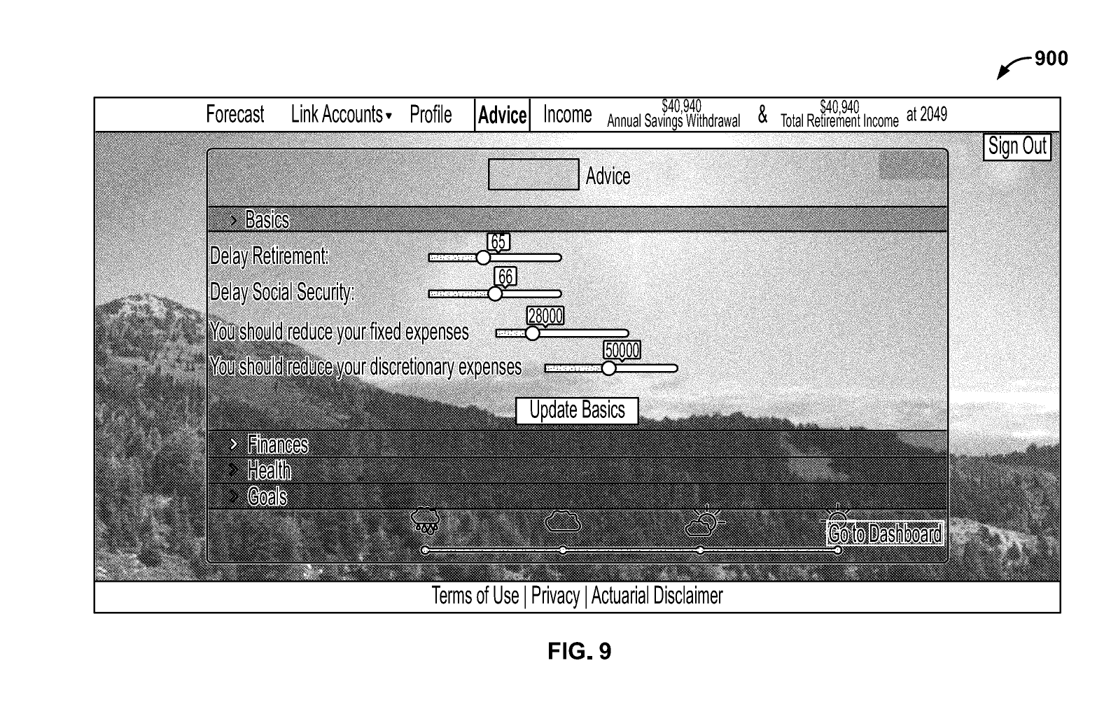

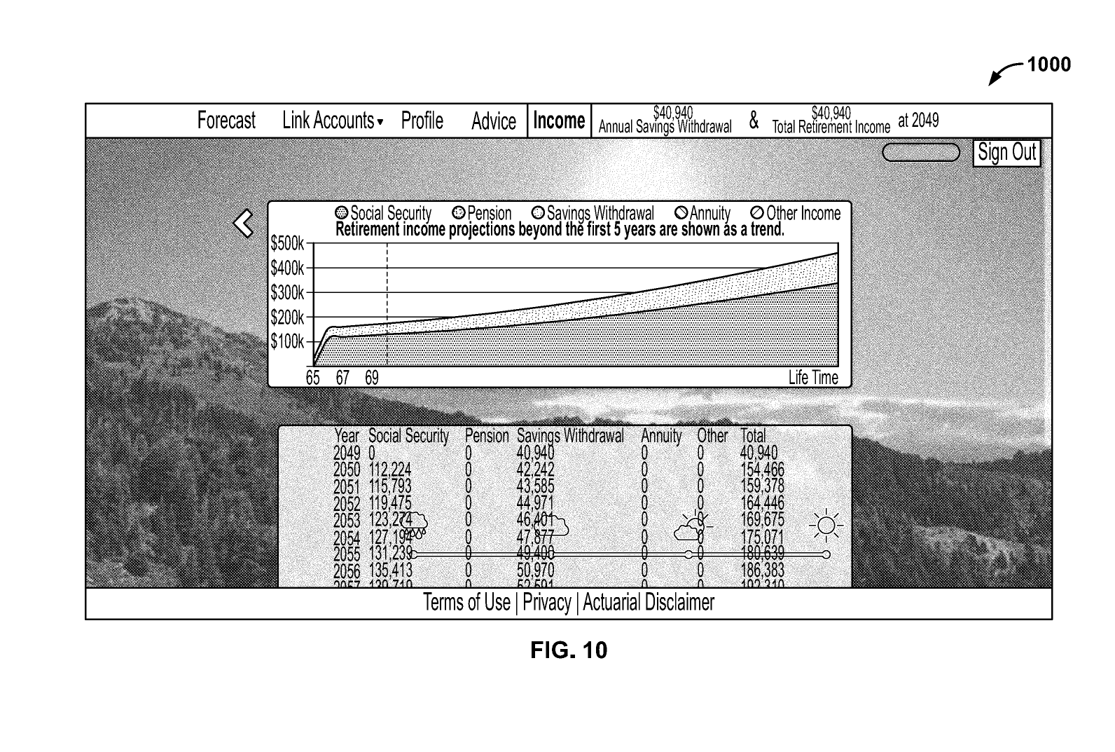

FIGS. 6-13 are example screenshots of a retirement strategy dashboard that facilitates implementing method 500 (shown in FIG. 5). Retirement strategy computing device 215 may cause the dashboard to be displayed, for example, on input information computing device 402 (shown in FIG. 3). FIG. 6 is a screenshot 600 prompting a user to input spending information (e.g., at block 502). FIG. 7 is a screenshot 700 prompting a user to input a retirement income priority (e.g., at block 510). FIG. 8 is a screenshot 800 prompting a user to input social security information (e.g., at block 502). FIG. 9 is a screenshot 900 displaying advice to a user (e.g., at block 526). FIG. 10 is a screenshot 1000 displaying a projected retirement income to a user.

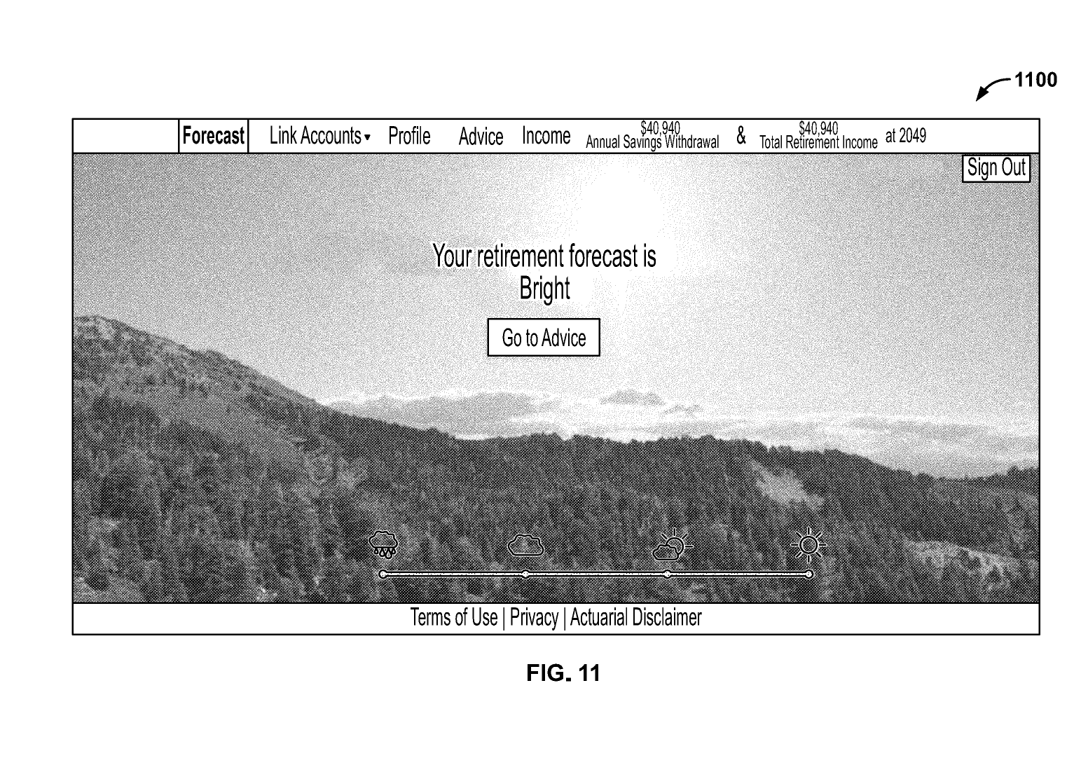

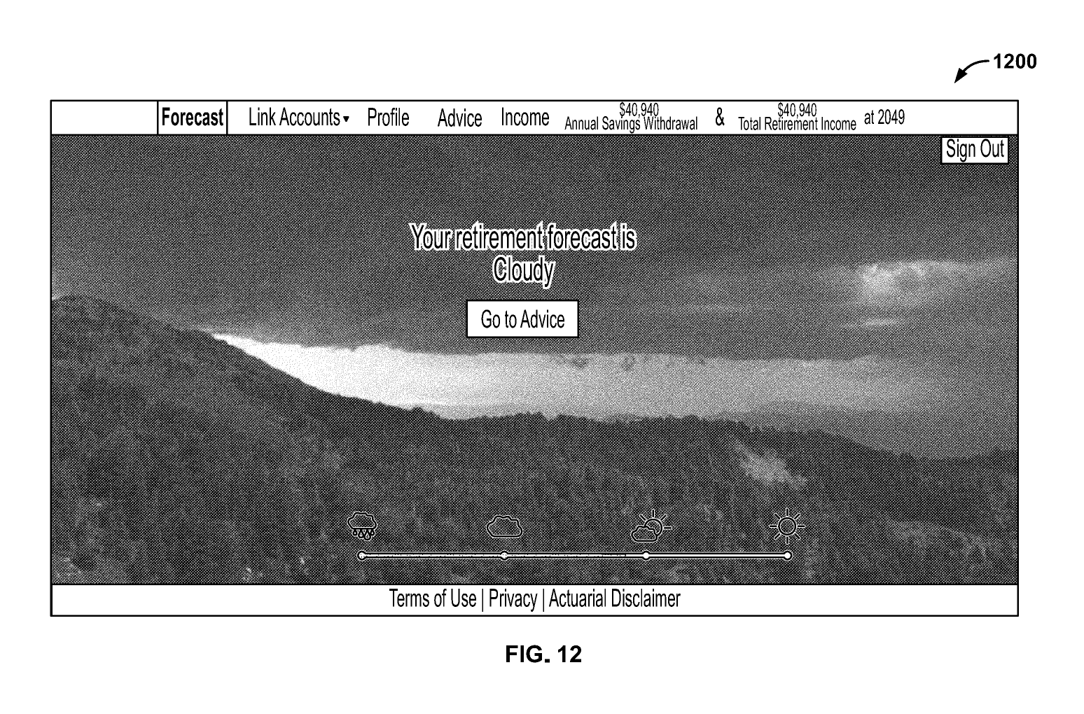

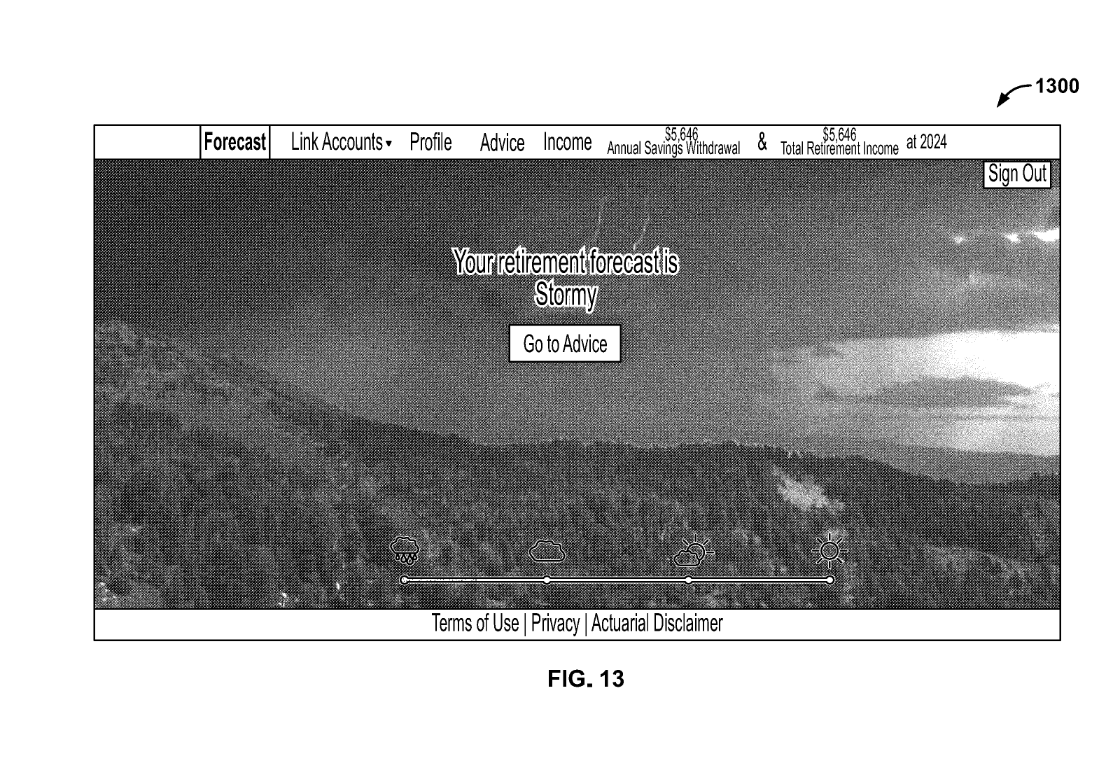

Notably, the individual can update information on the dashboard to see how it impacts their retirement outlook, or retirement forecast. FIG. 11 is a screenshot 1100 indicating a user has a good retirement forecast, FIG. 12 is a screenshot 1200 indicating a user has a moderate retirement forecast, and FIG. 13 is a screenshot 1300 indicating a user has a poor retirement forecast. Notably, a background (e.g., the type of weather displayed) of the dashboard updates in real-time as the individual takes one or more actions that change their retirement forecast. For example, if the individual adjusts a slider (as shown in FIG. 9) to delay their retirement or reduce their fixed expenses, the retirement forecast for the user will generally improve. Accordingly, in the exemplary embodiment, retirement strategy computing device 215 continuously monitors for changes in the information input by the individual (e.g., the position of the sliders). When retirement strategy computing device 215 detects a change in the input information, retirement strategy computing device 215 automatically determines an updated retirement forecast for the individual, and causes the background of the dashboard to update to match the updated retirement forecast. Thus, as an individual adjusts the input information (e.g., by manipulating sliders), retirement strategy computing device 215 dynamically updates the displayed background accordingly. As such, retirement strategy computing device 215 provides instantaneous, real-time feedback to the individual that indicates whether the inputs provided by the individual positively or negatively affect their retirement forecast.

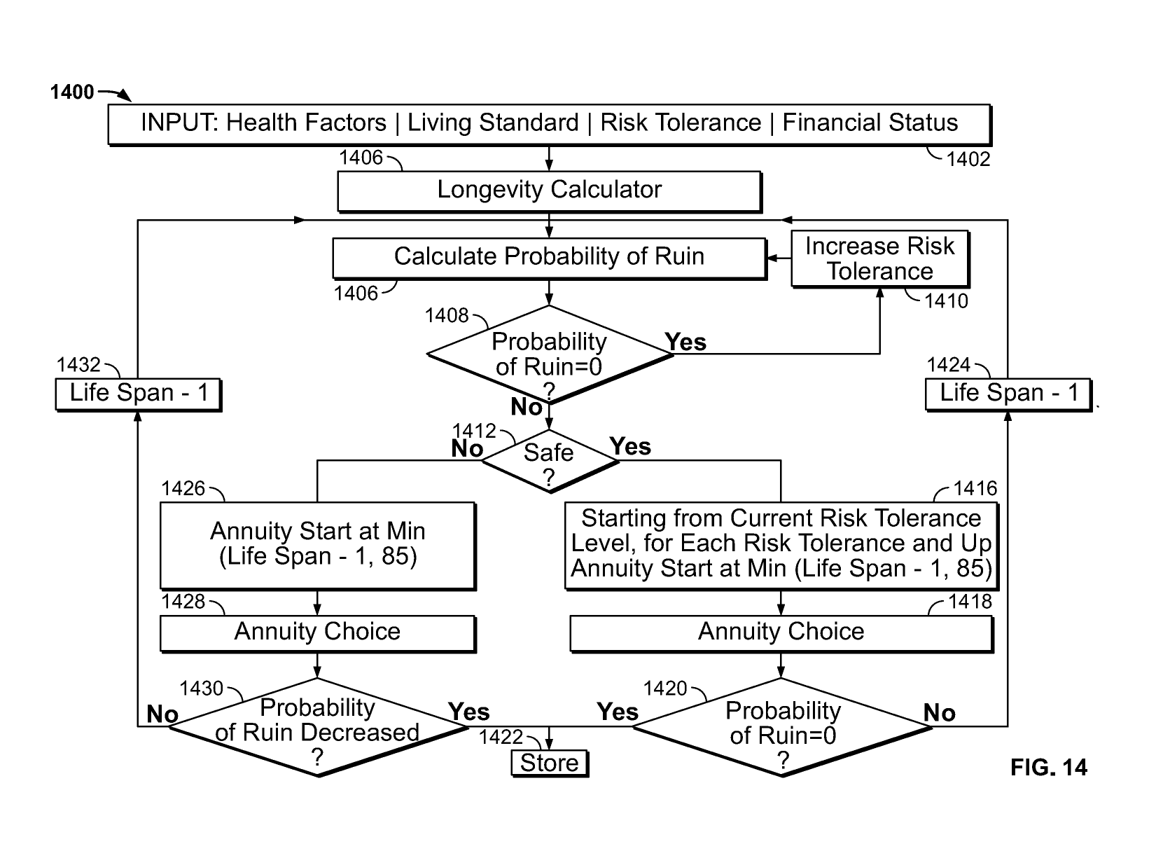

FIG. 14 is a flowchart of an alternative example method 1400 of generating a retirement strategy for an individual using retirement strategy system 200 (shown in FIG. 1). In the example embodiment, method 1400 is performed by retirement strategy computing device 215 (shown in FIG. 1).

At block 1402, input information for the individual is received. The input information may be received, for example, from input information computing device 402. In the example embodiment, the input information includes i) health factors, ii) a living standard, iii) a risk tolerance, and iv) a financial status. The health factors may be determined using a multi-question survey, and may include, for example, the individual's age, gender, weight, height, family history (e.g., of cardiovascular disease), blood pressure, stress level, exercise level, diet, propensity to wear a seat belt, propensity to drive, propensity to drink, propensity to smoke, and propensity to do drugs. The health factors are used to calculate an estimated lifespan, or longevity, of the individual.

Like the health factors, the living standard for the individual may also be determined using a multi-question survey. The living standard is used to estimate a retirement life expenditure (i.e., how much money the individual will spend during retirement). The risk tolerance and the financial status may also be determined based on a multi-question survey. The risk tolerance is used to calculate a risk tolerance level, n, and the financial status is used to assess the individual's personal investable wealth for calculating a probability of ruin for the individual. The risk tolerance level is also used to calculate the probability of ruin.

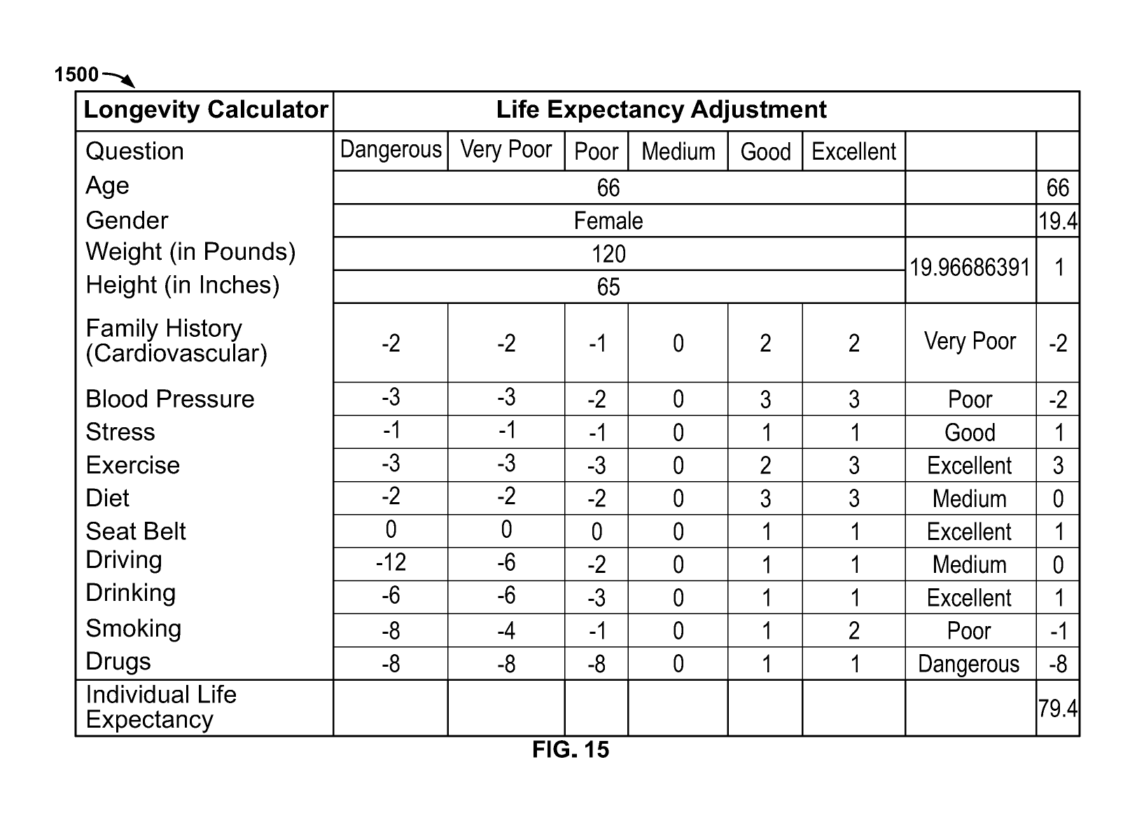

At block 1404, the health factors received in block 1402 are used to calculate an estimated lifespan, or longevity, of the individual. FIG. 15 is an example table 1500 that may be used to calculate longevity, Y. As shown in FIG. 15, table 1500 associates a score with each of a plurality of health factors, and calculates an individual life expectancy by summing all of the scores. Alternatively, the longevity of the individual may be calculated at block 1404 using any suitable calculation.

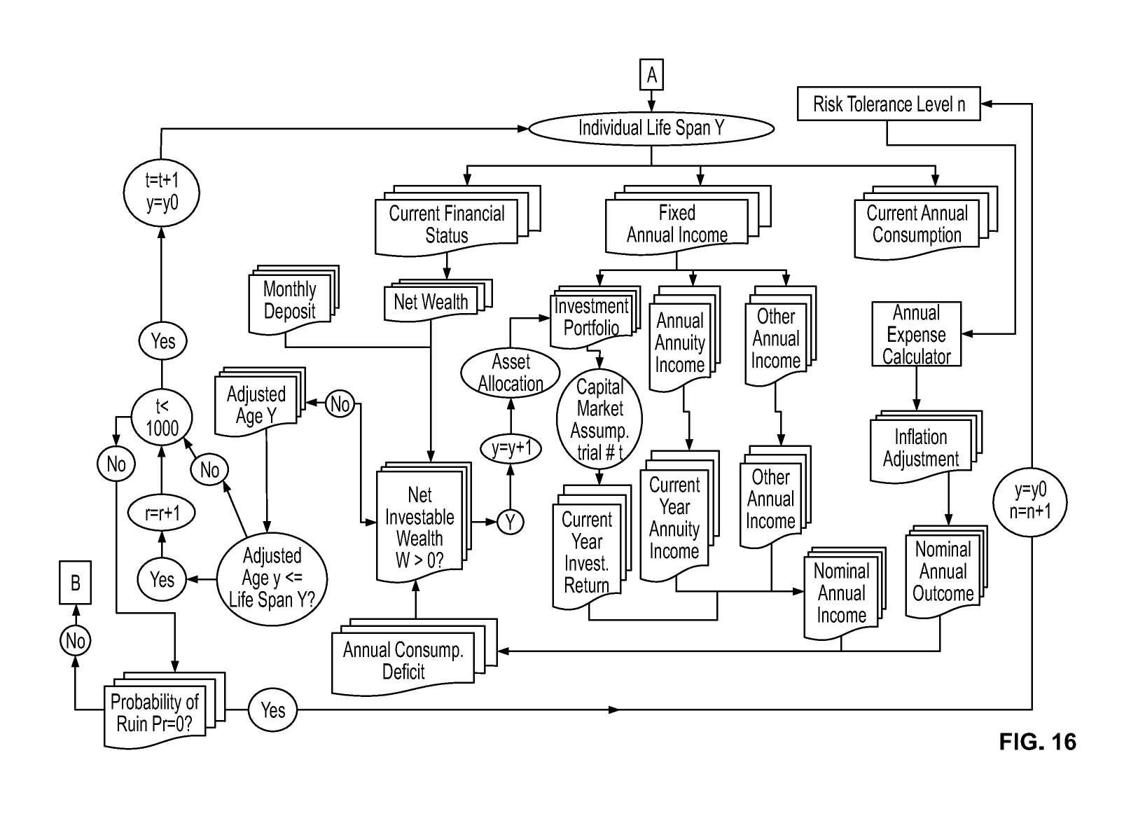

In the example embodiment, at block 1406, a probability of ruin, Pr, is calculated for the individual. Calculating the probability of ruin at block 1406 is an iterative process that executes an algorithm many (e.g., thousands of) times. This calculation utilizes the living standard, risk tolerance, and financial information received at block 1402. For example, the probability of ruin calculation may consider a current financial status of the individual (determined from at least the financial information), a fixed annual income of the individual (determined from at least the financial information), and a current annual consumption of the individual (determined from at least the financial information, living standard, and risk tolerance). The probability of ruin calculation also uses the longevity calculated at block 1404. An example embodiment of the probability of ruin calculation is described in detail below in reference to FIG. 16.

At block 1408, it is determined whether the calculated probability of ruin is substantially equal to zero (i.e., equal to zero or below some predetermined threshold (e.g., 0.01)). If the probability of ruin is substantially equal to zero, flow proceeds to block 1410, and the risk tolerance level, n, for the individual is increased. Flow then returns to block 1406, where the probability of ruin is recalculated based on the increased risk tolerance level.

If, however, at block 1408, the calculated probability of ruin is not substantially equal to zero (i.e., greater than or equal to the predetermined threshold), flow proceeds to block 1412, where a determination is made whether the individual is “safe”. A “safe” individual refers to an individual who likely does not need a QLAC, but can still be recommended a QLAC. In contrast, an individual who is not “safe” likely needs a QLAC to avoid ruin. An individual may be deemed “safe” if, for example, the probability of ruin for the individual is substantially equal to zero the first time that the probability of ruin calculation of block 1406 is performed. Alternatively, an individual may be deemed “safe” based on any criteria that enable method 1400 to function as described herein. For a “safe” individual, the systems and methods described herein facilitate maintaining a current probability of ruin and increasing an expenditure ability for the individual. For an individual who is not “safe”, the systems and methods described herein facilitate maintaining a current expenditure ability and decreasing a probability of ruin.

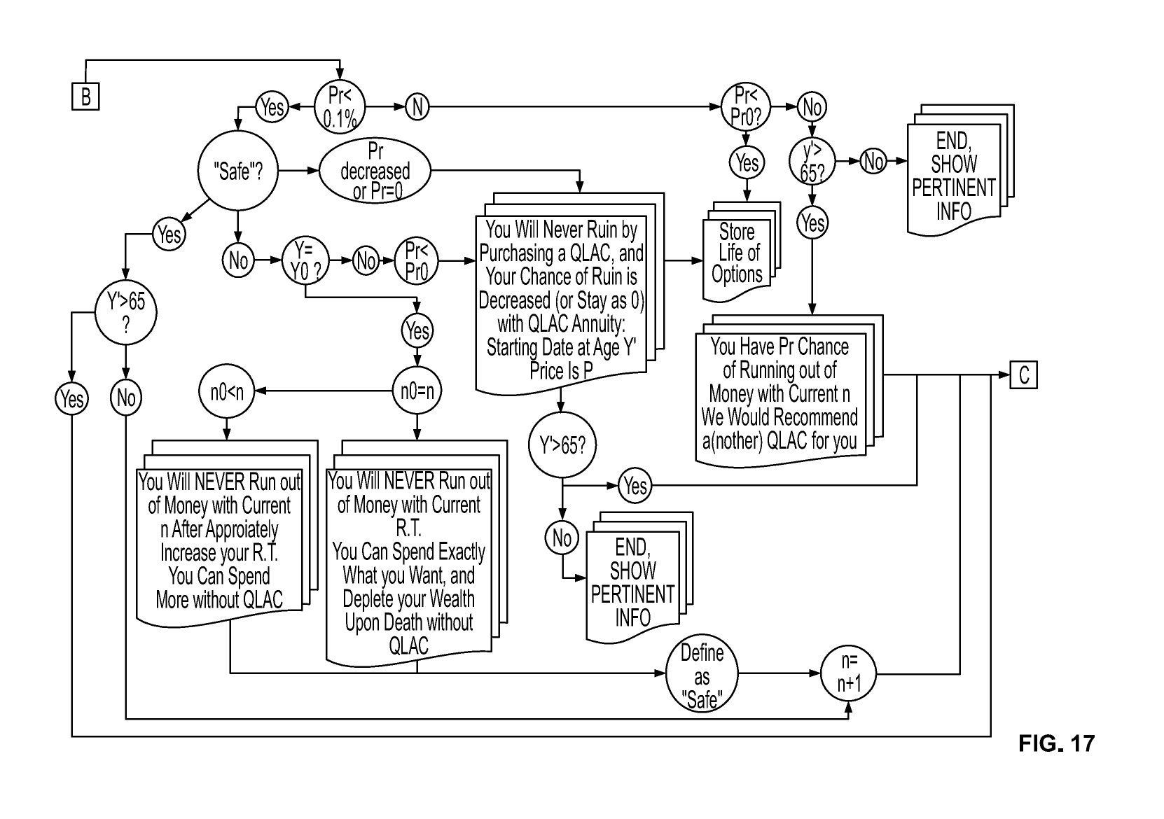

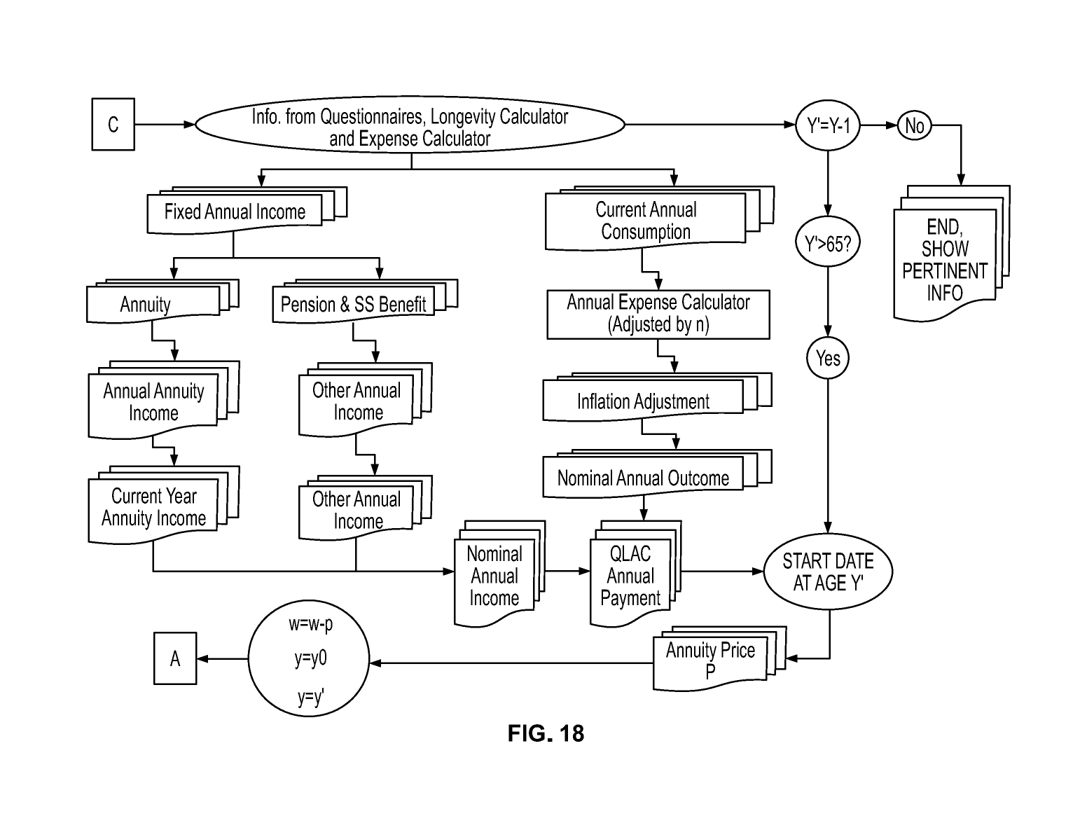

In the example embodiment, if the individual is “safe”, flow proceeds to block 1416, and starting from the current risk tolerance level for the individual, an annuity choice (i.e., a QLAC recommendation) is generated at block 1418. The annuity choice is generated based on, for example, the calculated probability of ruin and the calculated longevity. An example embodiment of the generation of QLAC recommendation is described in detail below in reference to FIGS. 17 and 18.

After the annuity choice is generated, flow proceeds to block 1420, and it is determined, based on the generated annuity choice, whether the probability of ruin is essentially zero. If the probability of ruin is essentially zero, flow proceeds to block 1422, and the generated annuity choice is stored such that it may be presented to the individual. If the probability of ruin is not essentially zero, flow proceeds to block 524, where the longevity is decremented, and flow then returns to block 1406.

If the individual is not determined to be “safe”, flow proceeds to block 1426, and an annuity choice (i.e., a QLAC recommendation) is generated at block 1428. The annuity choice is generated based on, for example, the calculated probability of ruin and the calculated longevity. An example embodiment of the generation of QLAC recommendation is described in detail below in reference to FIGS. 17 and 18.

After the annuity choice is generated, flow proceeds to block 1430. If the probability of ruin has decreased based on the generated annuity, flow proceeds to block 1422, and the generated annuity choice is stored such that it may be presented to the individual. If the probability of ruin has not decreased based on the generated annuity, flow proceeds to block 1432, where the longevity is decremented, and flow then returns to block 1406.

Notably, FIG. 14 is a simplified diagram of method 500. FIGS. 16-19, and the accompanying description, provide a detailed discussion of the example embodiment of method 1400. Specifically, FIG. 16 is a flow diagram illustrating detailed operation of block 1406 in the example embodiment, and FIGS. 17 and 18 are flow diagrams illustrating detailed operation of blocks 1412, 1416, 1418, 1422, 1424, 1426, 1428, 1430, and 1432 in the example embodiment.

As shown in FIG. 16, the probability of ruin calculation of block 1406 is an iterative calculation performed over a plurality of trails. More specifically, various financial criteria are considered to determine a net investable wealth, W, of the individual. If the determined net investable wealth is greater than zero, an adjusted age, y, for the individual is incremented, and at least some of the various financial criteria are again considered to determine a new net investable wealth. Once the determined net investable wealth is not greater than zero, a number of trials, t, is incremented, the adjusted age is reset to the individual's actual age, and the process begins again. Once the number of trials reaches a predetermined threshold (e.g., t=1000), flow proceeds to block 508 to determine whether the resulting probability of ruin is substantially equal to zero.

As shown in FIGS. 17 and 18, if the probability of ruin is not substantially equal to zero, retirement strategy computing device 215 performs a detailed analysis to determine what type of QLAC to recommend to the individual. More specifically, as shown in FIG. 17, retirement strategy computing device 215 considers at least age, probability of ruin, risk level, and whether the individual is deemed “safe”. Further, as shown in FIG. 18, various financial criteria are again considered to determine what type of QLAC to recommend. Specifically, to determine the type of QLAC, retirement strategy computing device 215 calculates i) an annuity price, p, ii) an annuity payment start date, and iii) an annuity payment amount. These values may be displayed on a user interface or dashboard as part of a QLAC recommendation. As shown in FIG. 18, in the example embodiment, under some circumstances, the annuity price is subtracted from the net investable wealth, the adjusted age is reset to the individual's actual age, the life expectancy is set to an adjusted life expectancy, Y′, and flow returns to block 1406.

As will be appreciated based on the foregoing specification, the above-described embodiments of the disclosure may be implemented using computer programming or engineering techniques including computer software, firmware, hardware or any combination or subset thereof, wherein the technical effect of the systems and processes described herein is achieved by creating a network-based system for generating a retirement strategy for an individual. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the disclosure, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for generating a retirement strategy for an individual, the method comprising:
receiving, at a retirement planning computing device, input information associated with the individual;
calculating, using the retirement planning computing device, a projected retirement wealth, a customized projected lifespan for the individual, and a customized market return for the individual based on the input information;
calculating, using the retirement planning computing device, a sustainable annual retirement income for the individual based on the projected retirement wealth, the customized projected lifespan, and the customized market return;
calculating, using the retirement planning computing device, a score that is indicative of the individual's projected wellbeing during retirement;
automatically generating, using the retirement planning computing device, advice for the individual based on the sustainable annual retirement income and the score; and
causing, using the retirement planning computing device, the sustainable annual retirement income, the score, and the advice to be displayed on a user computing device communicatively coupled to the retirement planning computing device.

2. The method of claim 1, wherein receiving input information comprises receiving input information that is input by the user on the user computing device.

3. The method of claim 1, wherein the input information includes an amount of current savings, an age, a gender, a marital status, a current salary, and a target retirement age.

4. The method of claim 1, wherein the projected retirement wealth is a projected initial wealth of the individual at the target retirement age.

5. The method of claim 1, wherein calculating a customized projected lifespan comprises calculating the customized projected lifespan using actuarial mortality tables and historical data.

6. The method of claim 1, wherein calculating a score comprises calculating the score based on a probability of ruin for the individual.

7. The method of claim 1, wherein automatically generating advice comprises automatically generating at least one of a qualified longevity annuity contract (QLAC) recommendation, an annuity recommendation, a Medicare recommendation, a long-term care plan recommendation, a charitable giving recommendation, and tax liability information.

8. The method of claim 7, wherein the tax liability information includes an indication of a tax liability difference between a first zip code and a second zip code.

9. The method of claim 1, wherein receiving input information comprises:
causing a multi-question survey to be displayed on the user computing device; and
receiving user inputs in response to the multi-question survey.

10. The method of claim 1, further comprising:
determining an initial retirement forecast for the individual based on the input information;
causing, based on the determined initial retirement forecast, a first background to be displayed on the user computing device, the first background including a weather image that corresponds to the initial retirement forecast;
automatically detecting updated input information input for the individual;
determining an updated retirement forecast for the individual based on the input information; and
dynamically updating the first background to a second background, the second background corresponding to the updated retirement forecast.

11. A retirement planning computing device for generating a retirement strategy for an individual, the retirement planning computing device comprising:
a memory device; and
a processor communicatively coupled to said memory device, said processor configured to:
receive input information associated with the individual;
calculate a projected retirement wealth, a customized projected lifespan for the individual, and a customized market return for the individual based on the input information;
calculate a sustainable annual retirement income for the individual based on the projected retirement wealth, the customized projected lifespan, and the customized market return;
calculate a score that is indicative of the individual's projected wellbeing during retirement;
automatically generate advice for the individual based on the sustainable annual retirement income and the score; and
cause the sustainable annual retirement income, the score, and the advice to be displayed on a user computing device communicatively coupled to the retirement planning computing device.

12. The computing device of claim 11, wherein to receive input information, said processor is configured to receive input information that is input by the user on the user computing device.

13. The computing device of claim 11, wherein the input information includes an amount of current savings, an age, a gender, a marital status, a current salary, and a target retirement age.

14. The computing device of claim 13, wherein the projected retirement wealth is a projected initial wealth of the individual at the target retirement age.

15. The computing device of claim 11, wherein to calculate a customized projected lifespan, said processor is configured to calculate the customized projected lifespan using actuarial mortality tables and historical data.

16. The computing device of claim 11, wherein to calculate a score, said processor is configured to calculate the score based on a probability of ruin for the individual.

17. The computing device of claim 11, wherein to automatically generate advice, said processor is configured to automatically generate at least one of a qualified longevity annuity contract (QLAC) recommendation, an annuity recommendation, a Medicare recommendation, a long-term care plan recommendation, a charitable giving recommendation, and tax liability information.

18. The computing device of claim 17, wherein the tax liability information includes an indication of a tax liability difference between a first zip code and a second zip code.

19. The computing device of claim 11, wherein said processor is further configured to:
determine an initial retirement forecast for the individual based on the input information;
cause, based on the determined initial retirement forecast, a first background to be displayed on the user computing device, the first background including a weather image that corresponds to the initial retirement forecast;
automatically detect updated input information input for the individual;
determine an updated retirement forecast for the individual based on the input information; and
dynamically update the first background to a second background, the second background corresponding to the updated retirement forecast.

20. A computer-implemented method for recommending a qualified longevity annuity contract (QLAC) for an individual, the method comprising:
receiving, at a retirement planning computing device, input information associated with the individual;
calculating, using the retirement planning computing device, an expected longevity for the individual based on the input information;
calculating, using the retirement planning computing device, a probability of ruin for the individual based on the expected longevity and the input information;
generating, using the retirement planning computing device, a QLAC recommendation for the individual based on the probability of ruin and the expected longevity, the QLAC recommendation including i) an annuity price, ii) an annuity payment start date, and iii) an annuity payment amount; and
causing, using the retirement planning computing device, the QLAC recommendation to be presented to the individual.
